(19) United States
(12) Patent Application Publication
(10) Pub. No.: US 2014/0339046 A1
(43) Pub. Date: Nov. 20, 2014

(54) Methods and Apparatuses for Rejecting Defective Absorbent Articles from a Converting Line

(71) Applicant: The Procter & Gamble Company, Cincinnati, OH (US)

(72) Inventors: Peter Wiedmann, Montgomery, OH (US); Todd Douglas Lenser, Liberty Township, OH (US); Ricky Reynaldo Yanez, Jr., Cincinnati, OH (US); Yoichiro Yamamoto, Koeln (DE); Andreas Josef Dreher, Cincinnati, OH (US)

(73) Assignee: The Procter & Gamble Company, Cincinnati, OH (US)

(21) Appl. No.: 14/273,671

(22) Filed: May 9, 2014

Related U.S. Application Data
(60) Provisional application No. 61/823,992, filed on May 16, 2013.

(51) Int. Cl. B65G 43/08

(52) U.S. Cl. CPC B65G 43/08
USPC 198/341.01

(57) ABSTRACT

The present disclosure relates to methods and apparatuses for rejecting defective absorbent articles from a converting line. At a downstream portion of a converting process, the continuous length of absorbent articles may be subjected to a final knife and cut to create separate and discrete absorbent articles in the form of diapers. From the final knife, the discrete absorbent articles may then advance in a first direction on a first carrier. A pneumatic system may be activated to redirect the leading end portion of a defective absorbent article advancing from the first carrier, while upstream of a second carrier. In turn, the redirected leading end portion of the defective absorbent article is transferred from the first carrier to a third carrier. And the third carrier advances the defective absorbent article with the third carrier along the reject article transport path away from the converting process.

### CROSS REFERENCE TO RELATED APPLICATION

This application claims the benefit of U.S. Provisional Application No. 61/823,992, filed on May 16, 2013, which is hereby incorporated by reference.

### FIELD OF THE INVENTION

The present disclosure relates to systems and methods for manufacturing disposable absorbent articles, and more particularly, systems and methods for rejecting defective absorbent articles from a converting line.

### BACKGROUND OF THE INVENTION

Along an assembly line, diapers and various types of other absorbent articles may be assembled by adding components to and otherwise modifying an advancing, continuous web of material. For example, in some processes, advancing webs of material are combined with other advancing webs of material. In other examples, individual components created from advancing webs of material are combined with advancing webs of material, which in turn, are then combined with other advancing webs of material. Webs of material and component parts used to manufacture diapers may include: backsheets, topsheets, absorbent cores, front and/or back ears, fastener components, and various types of elastic webs and components such as leg elastics, barrier leg cuff elastics, and waist elastics. Once the desired component parts are assembled, the advancing web(s) and component parts are subjected to a final knife cut to separate the web(s) into discrete diapers or other absorbent articles. The discrete diapers or absorbent articles may also then be folded and packaged.

For quality control purposes, absorbent article converting lines may utilize various types of sensors to detect defects in the webs and discrete components added to the webs along the converting line as absorbent articles are constructed. Example sensor technology may include vision systems, photoelectric sensors, proximity sensors, laser or sonic distance detectors, and the like. Sensor data may be communicated to a controller. In turn, the controller may be programmed to receive sensor data and reject or cull defective diapers after the final knife cut at the end of the converting line.

Various systems are used for rejecting defective diapers, such as by diverting the defective diapers from the stream of diapers that are of satisfactory condition or good quality. For example, one system that has been used to reject cut web products includes forcing the defective diapers out of the stream of satisfactory products by using pneumatic air blasts, which divert the defective diapers to a path that differs from that of the stream of satisfactory diapers. In such a method, the defective diapers are detected, and a pneumatic air blast from one or more nozzles forces the defective diapers out of the stream of quality products and into a reject bin provided in proximity of the conveyor system or production line.

In an effort to save on capital expenses, absorbent article manufacturers are often looking for ways produce more articles in shorter periods of time by increasing production line speeds. As production line speeds increase, the machine direction speeds at which assembled absorbent articles travel increase. As such, existing systems of rejecting cut web products may have some disadvantages that become accentuated as a result of the increased article travel speeds. For example, the energy associated with a moving absorbent article is a function of the square of the travel speed. Thus, existing reject systems that utilize pneumatic air blasts to divert defective diapers may not be capable of fully diverting defective articles from the converting line when operating at increased speeds. In some instances, defective articles may occasionally travel past reject systems to downstream converting operations, sometimes causing jams; production line stoppages; and/or damage to machinery.

Consequently, it would be beneficial to provide a system for high speed selective redirecting and/or rejecting of absorbent articles. In addition, a system that utilizes some or all existing equipment and/or control mechanisms to reject products rather than a complete replacement system to perform redirecting and/or rejecting operations may be desirable.

### SUMMARY OF THE INVENTION

The present disclosure relates to systems and methods for rejecting defective absorbent articles from a converting line.

In one form, a method for rejecting defective absorbent articles from a web converting manufacturing process includes the steps of: converting a substrate and component parts into a continuous length of absorbent articles; inspecting the substrate or component parts with a sensor; cutting the continuous length of absorbent articles into discrete absorbent articles, wherein each discrete absorbent article includes a first surface and a second surface opposite the first surface, and wherein each discrete absorbent article includes a leading end portion and a trailing end portion; advancing the discrete absorbent articles in a first direction on a first carrier; transferring discrete absorbent articles along an article trajectory plane from the first carrier to a second carrier; identifying a defective absorbent article; redirecting the leading end portion of the defective absorbent article advancing from the first carrier while upstream of the second carrier in a second direction to a reject article transport path that intersects the article trajectory plane; transferring the redirected leading end portion of the defective absorbent article from the first carrier to a third carrier; and advancing the defective absorbent article on the third carrier along the reject article transport path.

In another form, a method for rejecting defective absorbent articles from a web converting manufacturing process includes the steps of: converting a substrate and component parts into a continuous length of absorbent articles; inspecting the substrate or component parts with a sensor; cutting the continuous length of absorbent articles into discrete absorbent articles, wherein each discrete absorbent article includes a first surface and a second surface opposite the first surface, and wherein each discrete absorbent article includes a leading end portion and a trailing end portion; advancing the discrete absorbent articles in a first direction on a first carrier; transferring discrete absorbent articles from the first carrier across a gap to a second carrier; advancing discrete absorbent articles in a second direction on the second carrier; identifying a defective absorbent article; redirecting the leading end portion of the defective absorbent article in the gap in a third direction; transferring the leading end portion of the defective absorbent article from the first carrier to a third carrier; and advancing the defective absorbent article in the third direction on the third carrier.

In yet another form, an apparatus for rejecting defective absorbent articles from a web converting manufacturing process includes: a sensor adapted to detect defective absorbent articles; a knife adapted to cut discrete absorbent articles from a continuous length of absorbent articles; a first carrier adjacent the knife, wherein the first carrier receives discrete absorbent articles from the knife and advances the discrete in a first direction; a second carrier separated from the first carrier by a gap extending in the first direction, the second carrier adapted to receive absorbent articles from the first carrier so as to define an article trajectory plane; a third carrier below the article transport plane adapted to receive and advance rejected absorbent articles away from the article trajectory plane before being received by the second carrier; and an air nozzle above the article trajectory plane and adapted to discharge air across the gap to redirect defective absorbent articles in a downward direction to the third carrier.

### BRIEF DESCRIPTION OF THE DRAWINGS

FIG. 1 is a top plan view of a disposable absorbent article that may include one or more substrates and/or components monitored and constructed in accordance with the present disclosure.

FIG. 2 is a schematic representation of an absorbent article converting line and reject system.

FIG. 3 is a detailed schematic representation of a rejection system.

FIG. 4 is a detailed schematic representation of the rejection system showing non-defective absorbent articles advancing from a first carrier to a second carrier.

FIG. 5 is a detailed schematic representation of the rejection system showing a defective absorbent article being redirected by a pneumatic system before advancing to the second carrier.

FIG. 6 is a detailed schematic representation of the rejection system showing the defective absorbent article being advanced along an article reject path by a third carrier.

FIG. 7 is a detailed schematic representation of a rejection system wherein the third carrier is a rotating drum.

### DETAILED DESCRIPTION OF THE INVENTION

The following term explanations may be useful in understanding the present disclosure:

“Absorbent article” is used herein to refer to consumer products whose primary function is to absorb and retain soils and wastes. “Diaper” is used herein to refer to an absorbent article generally worn by infants and incontinent persons about the lower torso. The term “disposable” is used herein to describe absorbent articles which generally are not intended to be laundered or otherwise restored or reused as an absorbent article (e.g., they are intended to be discarded after a single use and may also be configured to be recycled, composted or otherwise disposed of in an environmentally compatible manner).

An “elastic,” “elastomer” or “elastomeric” refers to materials exhibiting elastic properties, which include any material that upon application of a force to its relaxed, initial length can stretch or elongate to an elongated length more than 10% greater than its initial length and will substantially recover back to about its initial length upon release of the applied force.

As used herein, the term “joined” encompasses configurations whereby an element is directly secured to another element by affixing the element directly to the other element, and configurations whereby an element is indirectly secured to another element by affixing the element to intermediate member(s) which in turn are affixed to the other element.

“Longitudinal” means a direction running substantially perpendicular from an end edge, such as a waist edge, to a longitudinally opposing end edge, or waist edge, of an absorbent article when the article is in a flat out, uncontracted state, or from a waist edge to the bottom of the crotch, i.e. the fold line, in a bi-folded article. Directions within 45 degrees of the longitudinal direction are considered to be “longitudinal.” “Lateral” refers to a direction running from a longitudinally extending side edge to a laterally opposing longitudinally extending side edge of an article and generally at a right angle to the longitudinal direction. Directions within 45 degrees of the lateral direction are considered to be “lateral.”

The term “substrate” is used herein to describe a material which is primarily two-dimensional (i.e. in an XY plane) and whose thickness (in a Z direction) is relatively small (i.e. 1/10 or less) in comparison to its length (in an X direction) and width (in a Y direction). Non-limiting examples of substrates include a web, layer or layers or fibrous materials, nonwovens, films and foils such as polymeric films or metallic foils. These materials may be used alone or may comprise two or more layers laminated together. As such, a web is a substrate.

The term “nonwoven” refers herein to a material made from continuous (long) filaments (fibers) and/or discontinuous (short) filaments (fibers) by processes such as spunbonding, meltblowing, carding, and the like. Nonwovens do not have a defined woven or knitted filament pattern.

The term “machine direction” (MD) is used herein to refer to the direction of material flow through a process. In addition, relative placement and movement of material can be described as flowing in the machine direction through a process from upstream in the process to downstream in the process.

The term “cross direction” (CD) is used herein to refer to a direction that is generally perpendicular to the machine direction.

The present disclosure relates to methods and apparatuses for manufacturing absorbent articles, and more particularly, systems and methods for rejecting defective absorbent articles from a converting line. As discussed in more detail below, during the converting process, various continuous substrates and/or discrete components may be combined with each other to form a continuous length of absorbent articles. At a downstream portion of the converting process, the continuous length of absorbent articles may be subjected to a final knife and cut to create separate and discrete absorbent articles in the form of diapers. Each discrete absorbent article includes a first surface and a second surface opposite the first surface, and each discrete absorbent article includes a leading end portion and a trailing end portion. From the final knife, the discrete absorbent articles may then advance in a first direction on a first carrier. Next, the discrete absorbent articles are transferred from the first carrier to a second carrier along an article trajectory plane. As discussed in more detail below, defective absorbent articles may be identified by an inspection system. In turn, the inspection system may be operably connected with a pneumatic system to remove the defective absorbent articles from the converting process before the defective absorbent articles are transferred to the second carrier. More particularly, the pneumatic system may be activated to redirect the leading end portion of a defective absorbent article advancing from the first carrier, while upstream of the second carrier, to a reject article transport path that intersects the article trajectory plane. In turn, the redirected leading end portion of the defective absorbent article is transferred from the first carrier to a third carrier. And the third carrier advances the defective absorbent article with the third carrier along the reject article transport path away from the converting process. Absorbent articles that are not deemed to be defective may be transferred to the second carrier from the first carrier and subject to further processing steps, such as for example, folding and packaging operations.

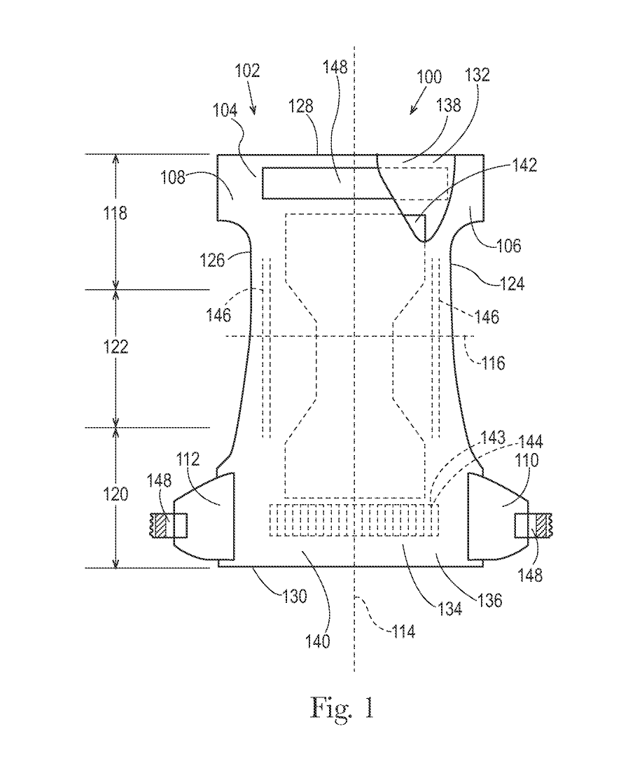

It is to be appreciated that although the methods and apparatuses herein may be configured to reject various types of products, the methods and apparatuses herein are discussed below in the context of manufacturing absorbent articles. In particular, the methods and apparatuses are discussed in the context of rejecting advancing, defective diapers during production. For the purposes of a specific illustration, FIG. 1 shows one example of a disposable absorbent article 100, such as described in U.S. Patent Publication Nos. US2008/0132865 A1 and US2011/0247199 A1, in the form of a diaper 102 that may be constructed from substrates and components monitored according to the systems and methods disclosed herein. In particular, FIG. 1 is a plan view of one embodiment of a diaper 102 including a chassis 104 shown in a flat, unfolded condition, with the portion of the diaper 102 that faces away from the wearer oriented towards the viewer. A portion of the chassis structure is cut-away in FIG. 1 to more clearly show the construction of and various features that may be included in embodiments of the diaper.

As shown in FIG. 1, the diaper 102 includes a chassis 104 having a first ear 106, a second ear 108, a third ear 110, and a fourth ear 112. To provide a frame of reference for the present discussion, the chassis 104 is shown with a longitudinal axis 114 and a lateral axis 116. The chassis 104 is shown as having a first waist region 118, a second waist region 120, and a crotch region 122 disposed intermediate the first and second waist regions. In some configurations, the first waist region 118 may correspond with a front waist region, and the second waist region 120 may correspond with a rear waist region. The periphery of the diaper is defined by a pair of longitudinally extending side edges 124, 126; a first outer edge 128 extending laterally adjacent the first waist region 118; and a second outer edge 130 extending laterally adjacent the second waist region 120. As shown in FIG. 1, the chassis 104 includes an inner, body-facing surface 132, and an outer, garment-facing surface 134. A portion of the chassis structure is cut-away in FIG. 1 to more clearly show the construction of and various features that may be included in the diaper. As shown in FIG. 1, the chassis 104 of the diaper 102 may include an outer covering layer 136 including a topsheet 138 and a backsheet 140. An absorbent core 142 may be disposed between a portion of the topsheet 138 and the backsheet 140. As discussed in more detail below, any one or more of the regions may be stretchable and may include an elastomeric material or laminate as described herein. As such, the diaper 102 may be configured to adapt to a specific wearer's anatomy upon application and to maintain coordination with the wearer's anatomy during wear.

The absorbent article may also include an elastic waist feature 143 shown in FIG. 1 in the form of a waist band 144 and may provide improved fit and waste containment. The elastic waist feature 143 may be configured to elastically expand and contract to dynamically fit the wearer's waist. The elastic waist feature 143 can be incorporated into the diaper and may extend at least longitudinally outwardly from the absorbent core 142 and generally form at least a portion of the first and/or second outer edges 128, 130 of the diaper 102. In addition, the elastic waist feature may extend laterally to include the ears. While the elastic waist feature 143 or any constituent elements thereof may comprise one or more separate elements affixed to the diaper, the elastic waist feature may be constructed as an extension of other elements of the diaper, such as the backsheet 140, the topsheet 138, or both the backsheet and the topsheet. In addition, the elastic waist feature 143 may be disposed on the outer, garment-facing surface 134 of the chassis 104; the inner, body-facing surface 132; or between the inner and outer facing surfaces. The elastic waist feature 143 may be constructed in a number of different configurations including those described in U.S. Patent Publication Nos. US2007/0142806A1; US2007/0142798A1; and US2007/0287983A1, all of which are hereby incorporated by reference herein.

As shown in FIG. 1, the diaper 102 may include leg cuffs 146 that may provide improved containment of liquids and other body exudates. In particular, elastic gasketing leg cuffs can provide a sealing effect around the wearer's thighs to prevent leakage. It is to be appreciated that when the diaper is worn, the leg cuffs may be placed in contact with the wearer's thighs, and the extent of that contact and contact pressure may be determined in part by the orientation of diaper on the body of the wearer. The leg cuffs 146 may be disposed in various ways on the diaper 102.

The diaper 102 may be provided in the form of a pant-type diaper or may alternatively be provided with a re-closable fastening system, which may include fastener elements in various locations to help secure the diaper in position on the wearer. For example, fastener elements 148 may be located on the first and second ears 110, 112 and may be adapted to releasably connect with one or more corresponding fastening elements located in the first or second waist regions. It is to be appreciated that various types of fastening elements may be used with the diaper.

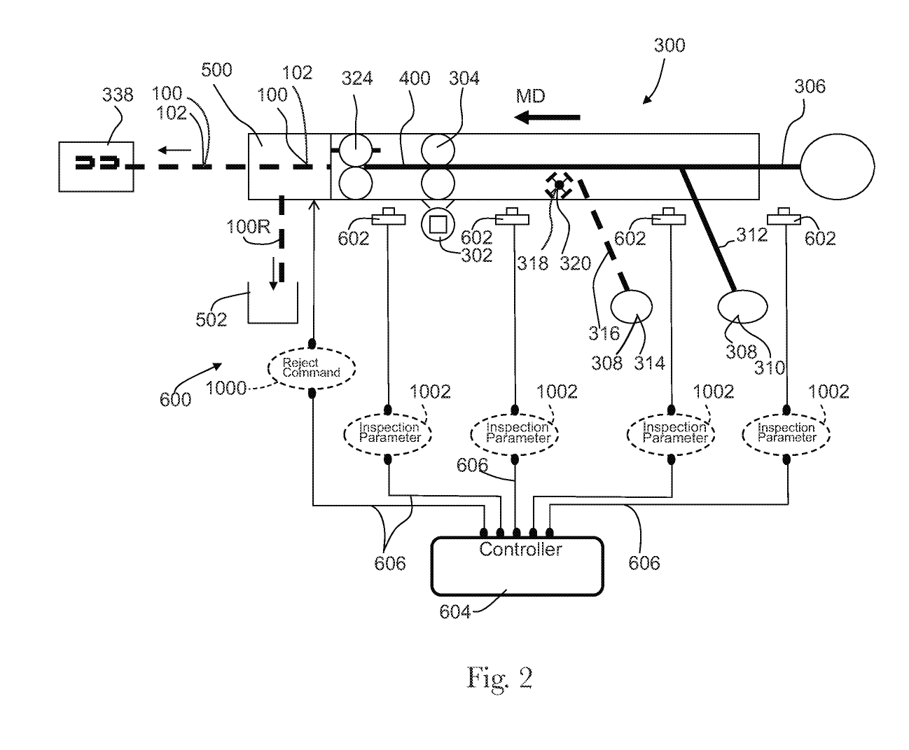

FIG. 2 shows a schematic representation of an absorbent article converting process including a converting line or machine 300 configured to manufacture absorbent articles 100. It is to be appreciated that the systems and methods disclosed herein are applicable to work with various types of converting processes and/or machines. As shown in FIG. 2, the converting line 300 may include one or more motors 302 that drive transport systems, such as a nip roll 304, to move diaper substrates and component materials through the manufacturing process. For example, FIG. 2 shows a base substrate 306 and two auxiliary substrates and/or components 308 of material used to construct portions of the diapers. The substrates may be provided as rolls and fed into the converting line 300. It is to be appreciated that material of the auxiliary substrates may be supplied in various ways. For example, FIG. 2 shows a first auxiliary substrate 310 in the form of a continuous substrate 312, and a second auxiliary substrate 314 in the form of individual components 316. It is to be appreciated that the auxiliary substrates 310 may be transferred to the base substrate through various types of transfer mechanisms. For example, the individual components 316 are shown as being transferred to the base substrate via a transfer mechanism 318 in the form of a servo patch placer mechanism 320, such as disclosed in U.S. Pat. Nos. 6,450,321; 6,705,453; 6,811,019; and 6,814,217. It is also to be appreciated that the various substrates can be used to construct various components of the absorbent articles, such as backsheets, topsheets, ears, leg cuffs, elastic waist features, and absorbent cores. Exemplary descriptions of absorbent article components are provided above with reference to FIG. 1.

Referring back to FIG. 2, as the base substrate 306 advances through the converting line 300, the base substrate 306 is combined with the auxiliary substrates 308 and/or discrete components 316 to create a continuous length of absorbent articles 400. At a downstream portion of the converting process 300, the continuous length of absorbent articles 400 is subjected to a final knife 324 and cut to create separate and discrete absorbent articles 100 in the form of diapers 102. As discussed in more detail below, an inspection system 600 may identify the defective absorbent articles 100R. In turn, defective articles 100R may be subject to a rejection system 500 and removed from the process. For example, FIG. 2 shows defective articles 100R being channeled to a reject bin 502. Articles 100 that are not deemed to be defective may be subject to further processing steps, such as folding and packaging. For example, FIG. 2 shows non-defective diapers 102 advancing from the final knife 324 to a folding mechanism 338.

It is to be appreciated that the term “reject bin” is used herein generically to designate the location where rejected diapers may be conveyed. As such, the reject bin 502 may include various systems. For example, the reject bin may 502 may include additional systems such as conveyors and/or pneumatic systems to provide additional transport or conveyance of rejected diapers to other locations.

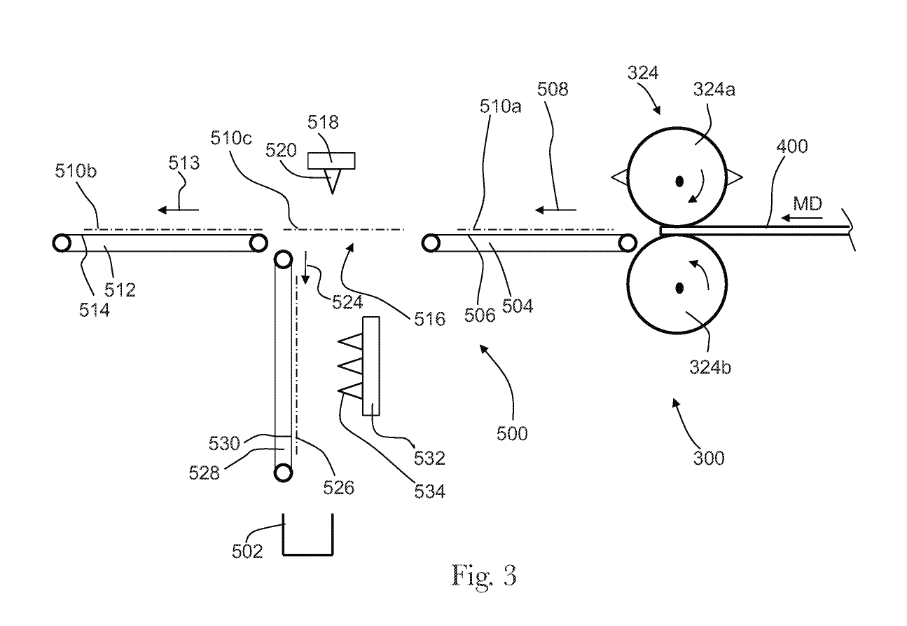

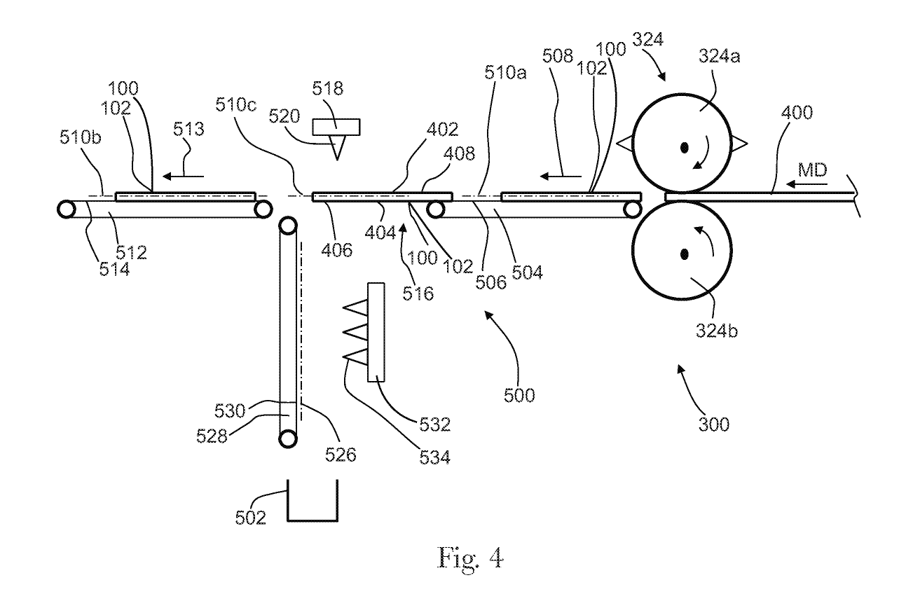

As mentioned above, the converting apparatus 300 includes a reject system 500 adapted to remove defective absorbent articles 100R from the converting process. For example, FIGS. 3 and 4 show a detailed schematic a downstream portion of a converting apparatus 300 that includes a reject system 500. As shown in FIGS. 3 and 4, a continuous length of absorbent articles 400 advances in a machine direction MD to a final knife 324 that cuts the continuous length of absorbent articles 400 into discrete absorbent articles 100. The final knife 324 may be configured in various ways. For example, the final knife 324 may include a knife roll 324a and an anvil roll 324b. Each discrete absorbent article 100 may be in the form of a diaper 102 and includes a first surface 402 and a second surface 404 opposite the first surface 402. In some configurations, where the absorbent articles 100 are in the form of diapers 102, the first surface 402 may correspond with the inner, body-facing surface 132 and/or topsheet 138, and the second surface 404 may correspond with the outer, garment-facing surface 134 and/or backsheet 140. In other configurations, the first surface 402 may correspond with the outer, garment-facing surface 134 and/or backsheet 140, and the second surface 404 may correspond with the inner, body-facing surface 132 and/or topsheet 138. Each discrete absorbent article 100 also includes a leading end portion 406 and a trailing end portion 408. In some configurations, where the absorbent articles 100 are in the form of diapers 102, the leading end portion 406 may correspond with the first waist region 118, and the trailing end portion 408 may correspond with the second waist region 120. In other configurations, the leading end portion 406 may correspond with the second waist region 120, and the trailing end portion 408 may correspond with the first waist region 118.

With continued reference to FIG. 4, the discrete absorbent articles 100 advance to a first carrier 504 from the final knife 324. The first carrier 504 may be in the form of belt conveyor and includes a carrier surface 506 that advances the discrete absorbent articles 100 in a first direction 508, wherein the first direction 508 may correspond with the machine direction MD. It is to be appreciated that the continuous length of absorbent articles 400 may advance to the final knife 324 at a first speed, V1. And the first carrier 504 may advance the discrete absorbent articles 100 from the final knife 324 at a second speed, V2. In some configurations, the second speed V2 may be greater than the first speed V1. And as such, the first carrier 504 may accelerate the discrete absorbent articles 100 advancing from the final knife 324 to the second speed V2, which in turn, causes consecutive absorbent articles 100 on the first carrier 504 to be spaced apart from each other along the first direction 508. As shown in FIG. 4, the second surfaces 404 of the absorbent articles 100 may be adjacent to and in contact with the carrier surface 506. Thus, the advancement of the discrete absorbent articles 100 in the first direction 508 on the first carrier 504 defines a first article transport plane 510a along which the absorbent articles 100 are transported.

Still referring to FIG. 4, the discrete absorbent articles 100 traveling along the first article transport plane 510a are transferred from the first carrier 504 to a second carrier 512 that advances the discrete absorbent articles in a second direction 513, wherein the first direction 508 may correspond with the machine direction MD. In addition, the second direction 513 may the same as or different from the first direction 508. Thus, the advancement of the discrete absorbent articles 100 in the second direction 513 on the second carrier 512 defines a second article transport plane 510b along which the absorbent articles 100 are transported. The second carrier 512 may also be in the form of belt conveyor and includes a carrier surface 514 that advances the discrete absorbent articles 100 that are not deemed to be defective to further processing steps, such as folding and packaging. As shown in FIGS. 3 and 4, a gap 516 separates the first carrier 504 and the second carrier 512 from each other. As such, non-defective absorbent articles 100 advance along the first article transport plane 510a from the first carrier 504, across the gap 516, and to the second carrier 512 to advance along the second article transport plane 510b. Thus, advancement of the non-defective absorbent articles 100 across the gap 516 defines an article trajectory plane 510c along which absorbent articles 100 travel from the first carrier 504 to the second carrier 512. It is to be appreciated that the first article transport plane 510a, the second article transport plane 510b, and/or the article trajectory plane 510c may be straight and/or curved.

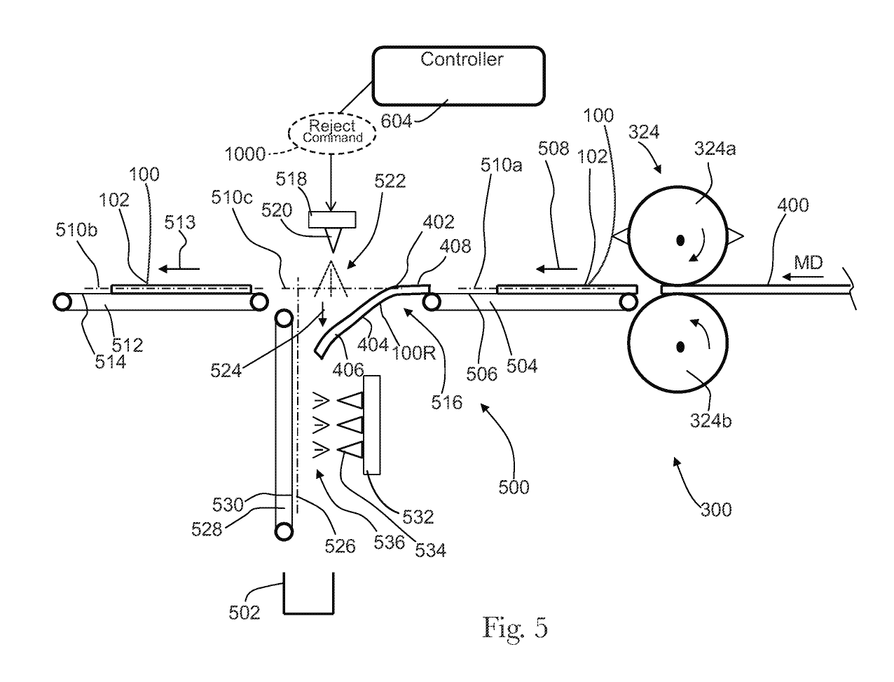

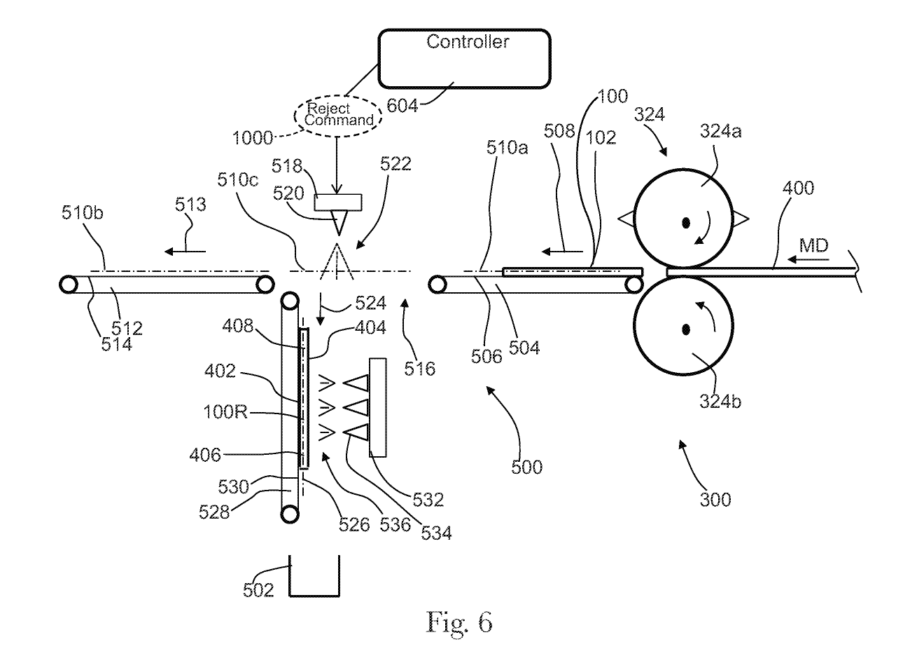

As previously mentioned, some absorbent articles 100 may be identified during assembly as defective absorbent articles 100R. As discussed below, an inspection system 600 may identify the defective absorbent articles 100R. In turn, the inspection system 600 may be operably connected with the reject system 500 to remove the defective absorbent articles 100R from the converting process before the defective absorbent articles are transferred to the second carrier 512. For example, as shown in FIGS. 3-6, the rejection system 500 may include a pneumatic system 518 that includes one or more nozzles 520 that can direct a pulse or blast of pressurized air 522 across the gap 516 to selectively activated to remove defective absorbent articles 100R. More particularly, as shown in FIG. 3-6, the nozzles 520 may be positioned above the article trajectory plane 510c and oriented so as direct air 522 downward and through the article trajectory plane 510c in the gap 516. In operation, the inspection system 600 may detect a defective absorbent article 100R. In turn, the inspection system 600 may activate the pneumatic system 518 to direct a pulse of air 522 onto the first surface 402 of the defective absorbent article 100R advancing through the gap 516. As such, the pulse of air 522 redirects the leading end portion 406 of the defective absorbent article 100R advancing from the first carrier 504, while upstream of the second carrier 512, in a third direction 524 to a reject article transport path 526 that intersects the article trajectory plane 510c. As shown in FIGS. 5 and 6, the redirected leading end portion 406 of the defective absorbent article 100R is transferred from the first carrier 504 to a third carrier 528. And the third carrier 528 advances the defective absorbent article 100R along the reject article transport path 526 away from the converting process to the reject bin 502. Once the detected defective absorbent articles 100R are removed from the converting process, the pneumatic system 518 is deactivated, which stops the pulses of air 522, resuming the transfer of absorbent articles 100 that are not deemed to be defective from the first carrier 504 to the second carrier 512.

As shown in FIGS. 3-6, the third carrier 528 may be in the form of belt conveyor and includes a carrier surface 530 that advances the rejected absorbent articles 100R along the reject article transport path 526. The third carrier 528 may be positioned and oriented such that the third carrier 528 and the carrier surface 530 do not intersect or cross the article trajectory plane 510c in the gap 516. For example, the third carrier 528 and carrier surface 530 may be positioned in close proximity with and below the article trajectory plane 510c. In addition, the reject article path 526 may be oriented in a downward direction. As such, absorbent articles 100 that are not deemed to be defective can advance across the gap 516 without colliding with the third carrier 528. However, as defective absorbent articles 100R are redirected in the gap 516 by the air 522, the leading end portion 406 of the redirected article 100R contacts the carrier surface 530 of the third carrier 528. As such, the location of the third carrier 528 helps to stop advancement of the defective absorbent article 100R toward the second carrier 512, and movement of the carrier surface 530 acts to help move the defective article 100R away from the article trajectory plane 510c.

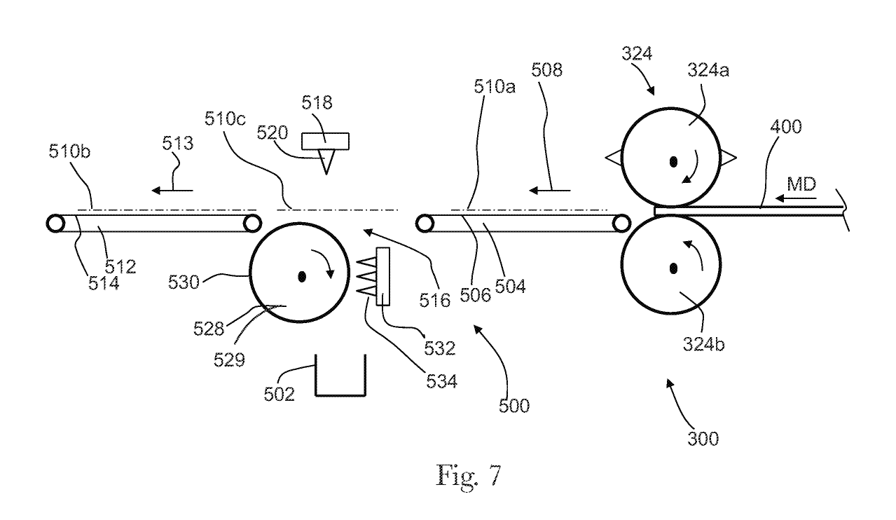

It is to be appreciated that the reject system 500 may be configured in various ways to help maintain contact between rejected absorbent articles 100R and the carrier surface 530 of the third carrier 528. For example, the carrier surface 530 may configured with various different surface textures to increase frictional forces between the carrier surface 530 and the first and/or second surfaces 402, 404 of the rejected absorbent articles 100R. In some configurations, the reject system 500 may include a second pneumatic system 532 including nozzles 534 that direct pressurized air 536 toward the carrier surface 530. For example, as shown in FIGS. 5 and 6, pressurized air 536 may be directed toward the second surface 406 of the rejected absorbent article 100R to help push the first surface 404 of the rejected article 100R against the carrier surface 530. It should also be appreciated that the carrier surface 530 may be configured as a porous and/or apertured belt or other foraminous carrier surface in fluid communication with a vacuum system. As such, suction forces from the vacuum system may be exerted on rejected absorbent articles 100R on the carrier surface 530. Some embodiments may be configured with additional mechanisms and/or systems to attract and/or hold rejected absorbent articles 100R to the carrier surface 530, such as for example, static electricity discharge bars and/or adhesive, alone or in combination with the second pneumatic system 532. In addition, although the third carrier 528 is depicted as belt conveyor, it is to be appreciated that the third carrier 528 may be configured in various ways. For example, in some embodiments, the third carrier 528 may be configured as a rotating drum 529, as shown in FIG. 7.

It is also to be appreciated that various components of the converting apparatus 300 may have various configurations. For example, although the first carrier 504 and the second carrier 512 are depicted as belt conveyors, it is to be appreciated that the first carrier 504 and/or the second carrier 512 may be configured in various ways. For example, in some embodiments, the first carrier 504 and/or second carrier 512 may be configured as a rotating drum. In order to help mitigate problems associated with uncontrolled movement of the discrete diapers 100 during conveyance, the first carrier 504 and/or second carrier 512 may also include a vacuum system in communication with a porous and/or apertured belt or other foraminous carrier surface 506, 514 that allows the suction force of the vacuum system to be exerted on absorbent articles 100. In some embodiments, additional belt conveyors may be located adjacent the first and/or second carriers 504, 512 to create a nip extending along the first and/or second directions 508, 513, wherein absorbent articles 100 are maintained in a flattened state while advancing through the nip.

As previously mentioned, the reject system 500 may be operably connected with an inspection system 600 to remove defective diapers 100R from the converting process in response to a reject command from the inspection system. More particularly, the methods and apparatuses 300 herein may also utilize inspection systems and processes for detecting and monitoring defective absorbent articles 100R during the manufacturing process. An embodiment of an inspection system 600 is schematically represented in FIG. 2. As discussed in more detail below, the inspection systems and methods may utilize feedback from technologies, such as vision systems, sensors, communication networks, and controllers. In some embodiments, the inspection systems may be configured to alarm and/or record occurrences of defective products during the manufacturing processes as well as remove defective products from the manufacturing process.

In some embodiments, the inspection system 600 may detect and/or track missing or defective components and/or substrates through the manufacturing process. The inspection system 600 may also correlate inspection results from such defective components and/or substrates to absorbent articles 100 made therefrom. In turn, the inspection system 600 may be used to control pneumatic systems 518 of the reject system 500 to reject defective absorbent articles 100R. In some configurations, defective articles 100R may be removed from the process, such as shown in FIG. 2, wherein defective diapers 100R are removed from converting line 300 while traveling from the final knife 324 and directed a reject bin 502. Diapers 100 that are not deemed to be defective may be transferred to the folding mechanism 338 and subject to further processing steps.

As shown in FIG. 2, the inspection system 600 may include a sensor 602 operatively connected with a controller 604. Various types of sensors 602 and other devices may be arranged adjacent the apparatus 300 and may communicate with the controller 604. Based on such communications, the controller 604 may monitor and affect various operations on the apparatus 300. As discussed in more detail below, for example, the controller 604 may send reject commands 1000 to affect operation of the reject system based on communications with the sensor 602.

It is to be appreciated that various types of controller and sensor configurations may be utilized with the inspection system 600, such as for example, disclosed in U.S. Pat. No. 8,145,338. For example, the controller 604 may include a computer system, which may, for example, include one or more types of programmable logic controller (PLC) and/or personal computer (PC) running software and adapted to communicate on an EthernetIP network. Some embodiments may utilize industrial programmable controllers such as the Siemens S7 series, Rockwell ControlLogix, SLC or PLC 5 series, or Mitsubishi Q series. The aforementioned embodiments may use a personal computer or server running a control algorithm such as Rockwell SoftLogix or National Instruments Labview or may be any other device capable of receiving inputs from sensors, performing calculations based on such inputs and generating control actions through servomotor controls, electrical actuators or electro-pneumatic, electrohydraulic, and other actuators.

It is to be appreciated that various different types of inspection sensors 602 may be used to monitor substrates and various components. For example, inspection sensors 602 may be configured as photo-optic sensors that receive either reflected or transmitted light and serve to determine the presence or absence of a specific material; metal-proximity sensors that use electromagnetic to determine the presence or absence of a ferromagnetic material; or capacitive or other proximity sensors using any of a number of varied technologies to determine the presence or absence materials. Inspection sensors 602 may also be configured as vision systems and other sub-processing devices to perform detection and, in some cases, logic to more accurately determine the status of an inspected product. Particular examples of such inspections sensors 602 may include Cognex Insight, DVT Legend or Keyence smart cameras, component vision systems such as National Instruments PXI or PC based vision system such as Cognex VisionPro or any other vision system software which can run on a PC platform.

As previously mentioned, the inspection sensors 602 may detect missing, misplaced, and/or defective and/or damaged components and/or substrates used in assembling absorbent articles 100. It is also to be appreciated that the inspection sensors 602 may be configured to perform various functions in the inspection system 600. For example, the sensors may be configured to detect defects within substrates and/or components themselves, such as for example, damage, holes, tears, dirt, and the like, and may also detect defective assemblies and/or combinations of the substrates and components, such as for example, missing and/or misplaced elastic material and the like. As such, inspection sensors may be configured to detect the presence or absence of substrates and/or components, and may be configured to detect the relative placement of substrates and/or components. As discussed in more detail below, based on the detections of the inspection sensors 602, feedback signals from the inspection sensors in the form of inspection parameters 1002 are communicated to the controller 604.

It should also be appreciated that inspection parameters 1002 may be provided from inspection sensors 602 in various forms. In some configurations, inspection parameters 1002 may be in the form of “results,” such as for example, provided from a sensor state change resulting in a binary input corresponding with the detected presence or absence of a defect, such as for example, the presence or absence of components and/or substrates. For example, inspection parameters 1002 may indicate the presence or absence of ears 110, 112. In other examples, an inspection parameter 1002 may indicate the presence or absence of a tear, hole, splice tape, and/or contaminants in the topsheet 138 and/or backsheet 140.

In some embodiments, inspection parameters 1002 may be provided in the form of measurements and/or numerical indications of detected positions of elastic material and/or substrates; numerical indications of the positions of elastic material and/or substrates relative to other elastic materials and/or substrates; and/or numerical indications of the positions of elastic materials and/or substrates relative to another physical or virtual reference. For example, inspection parameters 1002 may indicate the relative position of one feature of an absorbent article 100, such as an outer lateral edge of an elastic waistband 144, with respect to an outer edge 130. In other embodiments, inspection parameters 1002 may be in the form of images transferred via a standard protocol such as ftp (File Transfer Protocol), DDE (Dynamic Data Exchange), or OPC (Object Linking and Embedding for Process Control), which are stored in a database or stored in a specified directory on an image server for the purpose of either operator visualization, offline image processing or claim support.

As shown in FIG. 2, the inspection sensors 602 may be connected with the controller 604 through a communication network 606, which allows the inspection sensors 602 to communicate inspection parameters 1002 to the controller 604. The inspection sensors 602 and the controller 604 may be connected directly with the communication network 606. Such sensors may include, for example, vision systems such as National Instruments CVS or any PC-based vision system such as Cognex VisionPro. Such sensors may also include other controllers that may be configured as peers to the controller or may be configured as subordinate to the controller. In some embodiments, the inspection sensors 602 may be indirectly connected with the communication network 606. For example, the inspections sensors 602 may be connected with the communication network 606 through a remote input and output (I/O) station, such as discussed in U.S. Patent Publication No. 2010/0305740A1. When utilizing remote I/O stations, the inspection sensors 602 may be hardwired to the remote I/O stations, and in turn, the remote I/O stations may be connected with the communication network 606. Example remote I/O stations or other IEEE-1588 based instruments that can be utilized with systems and methods herein include, for example a National Instruments PCI-1588 Interface (IEEE 1588 Precision Time Protocol Synchronization Interface) that synchronizes PXI systems, I/O modules and instrumentation over Ethernet/IP or a Beckhoff Automation EtherCat and XFC technology (eXtreme Fast Control Technology).

In some embodiments, the inspection sensors 602 may communicate inspection parameters 1002 to the controller 604. In some instances, the inspection parameter 1002 may provide an indication of a defect in a substrate and/or component and/or defective assemblies and/or combinations of the substrates and components used to make absorbent articles 100. It is to be appreciated that the inspection system 600 may include inspection sensors 602 that monitor various locations of the manufacturing process in addition to the locations shown in FIG. 2. The detected defect may be tracked during the manufacturing process and correlated with a defective absorbent article 100R. In turn, the controller 604 of the inspection system 600 may send a reject command 1000 to one or more components of the converting apparatus 300, such as the reject system 500 to activate the pneumatic system 518 and direct a pulse of air 522 to remove the defective article 100R from the manufacturing process.

As previously mentioned, the inspection system 600 may be utilized with the apparatuses and methods 300 herein to detect and monitor defects during the manufacturing process. For example, as shown in FIG. 2, the sensors 602 may be configured to monitor components and substrates combined to create the continuous length of absorbent articles 400 in various stages of the assembly process. With continued reference to FIG. 2, the inspection system 600 may also correlate inspection results and measurements from defective substrates and components to defective absorbent articles 100R made therefrom. In turn, the inspection system 600 may be used to control an apparatus or system, wherein defective absorbent articles 100R are rejected. In some configurations, the controller 604 of the inspection system 600 may send a reject command 1000 to the pneumatic system 518, which in turn, removes defective articles 100R from the process, such as shown in FIGS. 5 and 6.

Although the present disclosure is provided in the context of manufacturing absorbent articles, and diapers in particular, it is to be appreciated that the systems and methods disclosed herein may be applied to the manufacture of various types of articles and products involving the monitoring of various different types of substrates and/or components. Examples of other products include absorbent articles for inanimate surfaces such as consumer products whose primary function is to absorb and retain soils and wastes that may be solid or liquid and which are removed from inanimate surfaces such as floors, objects, furniture and the like. Non-limiting examples of absorbent articles for inanimate surfaces include dusting sheets, pre-moistened wipes or pads, paper towels, dryer sheets. Additional examples of products include absorbent articles for animate surfaces whose primary function is to absorb and contain body exudates and, more specifically, devices which are placed against or in proximity to the body of the user to absorb and contain the various exudates discharged from the body. Non-limiting examples of incontinent absorbent articles include diapers, adult incontinence briefs and undergarments, feminine hygiene garments such as panty liners, absorbent inserts, and the like, toilet paper, tissue paper, facial wipes or cloths, toilet training wipes. Still other examples of products include packaging components and substrates and/or containers for laundry detergent, which may be produced in pellets or pouches and may be manufactured in a converting or web process or even discreet products produced at high speed such as high-speed bottling lines or cosmetics. Still other examples of products include a web substrate containing labels to be placed on bottles and/or containers for laundry detergent, fabric enhancers, hair and beauty care products, and cleaning products. Further, it is to be appreciated that although the present disclosure often refers to monitoring or viewing substrates and/or webs, it is to be appreciated that the inspection systems discussed herein can be used to monitor and/or view combinations of webs and individual components as well as parts added as a continuous web of material and parts added as a discontinuous web of material.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for rejecting defective absorbent articles from a web converting manufacturing process, the method comprising the steps of:
converting a substrate and component parts into a continuous length of absorbent articles;
inspecting the substrate or component parts with a sensor;
cutting the continuous length of absorbent articles into discrete absorbent articles, wherein each discrete absorbent article includes a first surface and a second surface opposite the first surface, and wherein each discrete absorbent article includes a leading end portion and a trailing end portion;
advancing the discrete absorbent articles in a first direction on a first carrier;
transferring discrete absorbent articles along an article trajectory plane from the first carrier to a second carrier;
identifying a defective absorbent article;
redirecting the leading end portion of the defective absorbent article advancing from the first carrier while upstream of the second carrier in a second direction to a reject article transport path that intersects the article trajectory plane;
transferring the redirected leading end portion of the defective absorbent article from the first carrier to a third carrier; and
advancing the defective absorbent article on the third carrier along the reject article transport path.

2. The method of claim 1, wherein the third carrier comprises a belt conveyor.

3. The method of claim 1, wherein the third carrier comprises a rotating drum.

4. The method of claim 1, wherein the step of redirecting further comprises discharging air from a nozzle onto the first surface of the defective absorbent article.

5. The method of claim 4, wherein the nozzle is above the article trajectory plane that discharges air downward across the article trajectory plane.

6. The method of claim 1, wherein the third carrier is below the article trajectory plane.

7. The method of claim 1, further comprising the step of holding the defective absorbent article onto the third carrier by discharging air onto the second surface of the defective absorbent article.

8. The method of claim 1, further comprising the steps of:
advancing the continuous length of absorbent articles at a first speed; and
accelerating the discrete absorbent articles on the first carrier to a second speed that is greater than the first speed.

9. The method of claim 1, wherein the first carrier comprises a belt conveyor.

10. The method of claim 1, wherein the second carrier comprises a belt conveyor.

11. A method for rejecting defective absorbent articles from a web converting manufacturing process, the method comprising the steps of:
converting a substrate and component parts into a continuous length of absorbent articles;
inspecting the substrate or component parts with a sensor;
cutting the continuous length of absorbent articles into discrete absorbent articles, wherein each discrete absorbent article includes a first surface and a second surface opposite the first surface, and wherein each discrete absorbent article includes a leading end portion and a trailing end portion;
advancing the discrete absorbent articles in a first direction on a first carrier;
transferring discrete absorbent articles from the first carrier across a gap to a second carrier;
advancing discrete absorbent articles in a second direction on the second carrier;
identifying a defective absorbent article;
redirecting the leading end portion of the defective absorbent article in the gap in a third direction;
transferring the leading end portion of the defective absorbent article from the first carrier to a third carrier; and
advancing the defective absorbent article in the third direction on the third carrier.

12. The method of claim 11, wherein the third carrier comprises a belt conveyor.

13. The method of claim 12, wherein the step of redirecting further comprises discharging air from a nozzle onto the first surface of the defective absorbent article.

14. The method of claim 13, further comprising the step of holding the defective absorbent article onto the third carrier.

15. The method of claim 14, wherein the step of holding further comprises discharging air onto the second surface of the defective absorbent article.

16. The method of claim 11, further comprising the steps of:
advancing the continuous length of absorbent articles at a first speed; and
accelerating the discrete absorbent articles on the first carrier to a second speed that is greater than the first speed.

17. The method of claim 11, wherein the first carrier comprises a belt conveyor.

18. An apparatus for rejecting defective absorbent articles from a web converting manufacturing process, the apparatus comprising:
a sensor adapted to detect defective absorbent articles;
a knife adapted to cut discrete absorbent articles from a continuous length of absorbent articles;
a first carrier adjacent the knife, wherein the first carrier receives discrete absorbent articles from the knife and advances the discrete in a first direction;
a second carrier separated from the first carrier by a gap extending in the first direction, the second carrier adapted to receive absorbent articles from the first carrier so as to define an article trajectory plane;
a third carrier below the article transport plane adapted to receive and advance rejected absorbent articles away from the article trajectory plane before being received by the second carrier; and
an air nozzle above the article trajectory plane and adapted to discharge air across the gap to redirect defective absorbent articles in a downward direction to the third carrier.

19. The apparatus of claim 18, wherein the third carrier comprises a belt conveyor.

20. The apparatus of claim 18, wherein the third carrier comprises a rotating drum.
